(19) United States
(12) Patent Application Publication
(10) Pub. No.: US 2013/0063585 A1
(43) Pub. Date: Mar. 14, 2013

(54) INFORMATION PROCESSING APPARATUS, INFORMATION PROCESSING METHOD, AND PROGRAM

(71) Applicants: Hirofumi Watanabe, Kanagawa (JP); Masato Kajimoto, Chiba (JP); Masashi Kimoto, Tokyo (JP); Masahiro Takahashi, Kanagawa (JP); Seiji Miyama, Kanagawa (JP)

(72) Inventors: Hirofumi Watanabe, Kanagawa (JP); Masato Kajimoto, Chiba (JP); Masashi Kimoto, Tokyo (JP); Masahiro Takahashi, Kanagawa (JP); Seiji Miyama, Kanagawa (JP)

(73) Assignee: SONY CORPORATION, Tokyo (JP)

(21) Appl. No.: 13/604,186

(22) Filed: Sep. 5, 2012

(30) Foreign Application Priority Data
Sep. 9, 2011 (JP) 2011-196813

(51) Int. Cl. H04N 7/18

(52) U.S. Cl. 348/79; 348/E07.085

(57) ABSTRACT

An information processing apparatus includes a storage unit, a determination unit, and a generation unit. The storage unit stores a plurality of partial images obtained by taking images with respect to a subject so that a plurality of image taking areas are overlapped with each other and relative positional displacement information of two adjacent partial images out of the plurality of partial images, the positional displacement information being calculated for each of the two adjacent partial images. The determination unit determines at least one display partial image for generating a display area image from the plurality of partial images, the display area image being an image of an area displayed as an image of the subject. The generation unit connects, when a plurality of display partial images are determined, the plurality of display partial images on the basis of the positional displacement information, to generate the display area image.

### CROSS REFERENCES TO RELATED APPLICATIONS

The present application claims priority to Japanese Priority Patent Application JP 2011-196813 filed in the Japan Patent Office on Sep. 9, 2011, the entire content of which is hereby incorporated by reference.

### BACKGROUND

The present disclosure relates to an information processing apparatus and an information processing method which are capable of synthesizing a plurality of images, and a program therefor.

In the past, a stitching technique for synthesizing a plurality of partial images obtained by partially taking images of a subject to generate one subject image has been known. The stitching technique is used for a generation of a panorama image, a generation of a scaled-up image with the use of a microscope, or the like. For example, Japanese Patent Application Laid-open No. HEI09-91410 (Hereinafter, referred to as Patent Document 1) discloses a panorama image synthesis system which is intended to appropriately synthesize a plurality of images.

### SUMMARY

However, even if the technique or the like disclosed in Patent Document 1 is used, an error may be caused in positions of a plurality of images synthesized by the stitching technique. In other words, a displacement may occur between the images adjacent to each other. For example, in the case where a large number of images are synthesized to generate one image, the displacement between the images adjacent to each other is accumulated, with the result that a large displacement may be generated ultimately.

In view of the above-mentioned circumstances, it is desirable to provide an information processing apparatus, an information processing method, and a program which are capable of suppressing the accumulation of the displacement between partial images adjacent to each other.

According to an embodiment of the present disclosure, there is provided an information processing apparatus including a storage unit, a determination unit, and a generation unit.

The storage unit is configured to store a plurality of partial images obtained by taking images with respect to a subject so that a plurality of image taking areas are overlapped with each other and relative positional displacement information of two adjacent partial images out of the plurality of partial images. The positional displacement information is calculated for each of the two adjacent partial images.

The determination unit is configured to determine at least one display partial image for generating a display area image from the plurality of partial images stored. The display area image is an image of an area displayed as an image of the subject.

The generation unit is configured to connect, when the determination unit determines a plurality of display partial images, the plurality of display partial images to each other on the basis of the positional displacement information stored, to generate the display area image.

In the information processing apparatus, the plurality of partial images and the positional displacement information calculated for each of two adjacent partial images are stored. Further, the at least one display partial image for generating the display area image is determined. In the case where the plurality of display partial images are determined, the plurality of display partial images are synthesized on the basis of the positional displacement information to generate the display area image. Thus, the display area image is generated as appropriate in accordance with the area displayed as a subject image, so it is possible to suppress an accumulation of the displacement between the adjacent partial images.

When the determination unit determines one display partial image, the generation unit may generate the display area image on the basis of the one display partial image.

The plurality of partial images each have a connection area corresponding to a part where the plurality of image taking areas are overlapped with each other. Therefore, the range of the display area image which can be generated from one partial image is large. As a result, it is possible to generate the display area image with high accuracy.

When a determination result by the determination unit is changed, the generation unit may use a connection result of the plurality of display partial images before the change to connect the plurality of display partial images after the change to each other.

For example, there is a case where the plurality of display partial images are changed by a movement or the like of the display area. In this case, with the use of the connection result of the plurality of display partial images before being changed, the plurality of display partial images that have been changed are connected to each other. As a result, it is possible to carry out the movement or the like of the display area with high accuracy.

The storage unit may store a reliability of the positional displacement information. In this case, the generation unit may connect the plurality of display partial images to each other on the basis of the reliability.

In this way, on the basis of the reliability of the positional displacement information, the plurality of display partial images may be connected to each other. As a result, it is possible to generate the display area image with high accuracy.

When the reliability of the positional displacement information of two adjacent display partial images is smaller than a predetermined value, the generation unit may use the positional displacement information between the two display partial images and the partial image which is not determined as the display partial image and is adjacent to the two display partial images, to connect the two display partial images to each other.

In this way, in the case where the reliability of the positional displacement information of the display partial images is smaller than the predetermined value, the positional displacement information between the two display partial images and the partial image which is not determined as the display partial image may be used. As a result, it is possible to generate the display area image with high accuracy.

The generation unit may use the positional displacement information between the display partial image and the partial image which is not determined as the display partial image, to generate the display area image.

In this way, to generate the display area image, the positional displacement information between the display partial image and the partial image which is not determined as the display partial image may be used. As a result, it is possible to generate the display area image with high accuracy.

The information processing apparatus may further include an instruction input unit configured to receive an instruction to change a relative position of two adjacent display partial images in the display area image generated by connecting the plurality of display partial images to each other. In this case, the generation unit may connect the plurality of display partial images to each other on the basis of the change instruction received.

As a result, it is possible to correct the relative positional relationship between the two display partial images while visually confirming the display area image, for example.

According to another embodiment of the present disclosure, there is provided an information processing method including storing a plurality of partial images obtained by taking images with respect to a subject so that a plurality of image taking areas are overlapped with each other and relative positional displacement information of two adjacent partial images out of the plurality of partial images. The positional displacement information is calculated for each of the two adjacent partial images.

At least one display partial image for generating a display area image is determined from the plurality of partial images stored, and the display area image is an image of an area displayed as an image of the subject.

When the determination unit determines a plurality of display partial images, the plurality of display partial images are connected to each other on the basis of the positional displacement information stored, to generate the display area image.

According to another embodiment of the present disclosure, there is provided a program causing a computer to execute the information processing method described above.

As described above, according to the embodiments of the present disclosure, it is possible to suppress the accumulation of the displacement between the partial images adjacent to each other.

These and other objects, features and advantages of the present disclosure will become more apparent in light of the following detailed description of best mode embodiments thereof, as illustrated in the accompanying drawings.

Additional features and advantages are described herein, and will be apparent from the following Detailed Description and the figures.

### BRIEF DESCRIPTION OF THE FIGURES

FIG. 1 is a schematic diagram showing an image processing system according to a first embodiment of the present disclosure;

FIG. 2 is a schematic diagram showing a structural example of a digital microscope and a control PC shown in FIG. 1;

FIG. 3 is a schematic diagram showing a hardware structural example of a server serving as an information processing apparatus according to the first embodiment;

FIG. 4 is a schematic diagram showing an outline of an operation of the image processing system shown in FIG. 1;

FIGS. 5A through 5C are diagrams for explaining a generation process of a plurality of partial images and an offset value by the control PC shown in FIG. 1;

FIGS. 6A and 6B are diagrams for explaining the generation process of the plurality of partial images and the offset value by the control PC shown in FIG. 1;

FIG. 7 is a schematic diagram showing an example of a data format of the offset value and a reliability according to the first embodiment;

FIG. 8 is a schematic diagram showing the outline of the operation of the server according to the first embodiment;

FIG. 9 is a flowchart showing an operation example of the server according to the first embodiment;

FIG. 10 is a diagram for explaining a determination process of a display area and display partial images according to the first embodiment;

FIG. 11 is a diagram for explaining the number of display partial images according to the first embodiment;

FIG. 12 is a diagram for explaining a method of generating a display area image cited as a comparative example;

FIG. 13 is a flowchart showing an operation example of a server according to a second embodiment of the present disclosure;

FIGS. 14A through 14C are schematic diagrams for explaining the operation example shown in FIG. 13;

FIG. 15 is a flowchart showing an operation example of a server serving as an information processing apparatus according to a third embodiment of the present disclosure;

FIG. 16 is a schematic diagram for explaining the operation example shown in FIG. 15;

FIG. 17 is a schematic diagram showing an outline of an operation of a server serving as an information processing apparatus according to a fourth embodiment of the present disclosure;

FIG. 18 is a flowchart showing an operation example of the server according to the fourth embodiment;

FIGS. 19A and 19B are schematic diagrams showing an example of a UI for a change mode of a joining position between the display partial images according to the fourth embodiment;

FIG. 20 is a schematic diagram showing an outline of an operation of an image processing system according to a fifth embodiment of the present disclosure; and

FIG. 21 is a schematic diagram for explaining a modified example of the determination process of the display area and the display partial images shown in FIG. 10.

### DETAILED DESCRIPTION

Hereinafter, embodiments of the present disclosure will be described with reference to the drawings.

### First Embodiment

(Structure of Image Processing System)

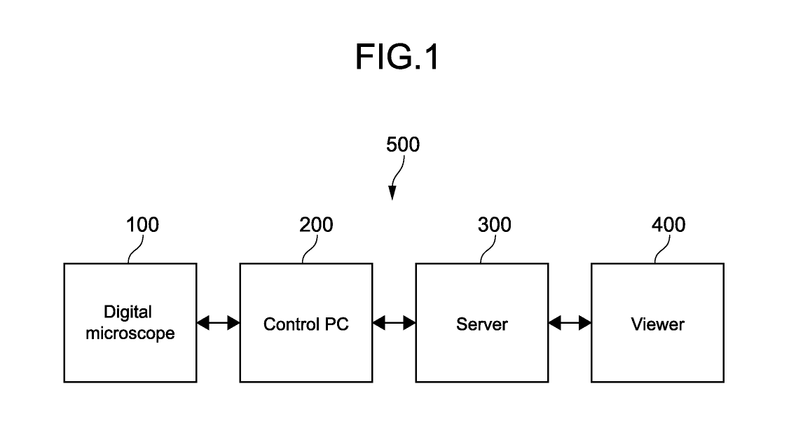

FIG. 1 is a schematic diagram showing an image processing system according to a first embodiment of the present disclosure. As shown in the figure, an image processing system 500 has a digital microscope 100, a control PC (Personal Computer) 200, a server 300, and a viewer 400. Here, the server 300 functions as an information processing apparatus according to this embodiment.

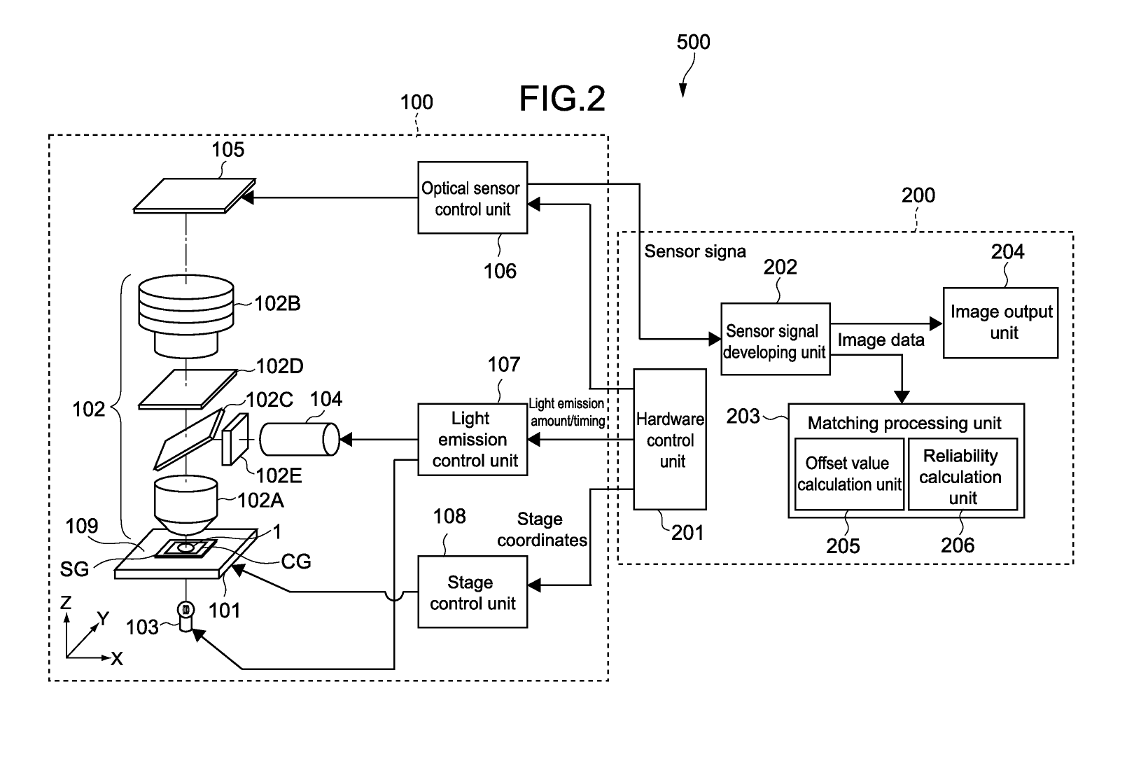

FIG. 2 is a schematic diagram showing a structural example of the digital microscope 100 and the control PC 200.

The digital microscope 100 has a stage 101, an optical system 102, an illumination lamp 103, a light source 104, an optical sensor 105, an optical sensor control unit 106, a light emission control unit 107, and a stage control unit 108.

The stage 101 has a placement surface 109 on which a subject 1 as an image taking target is placed. The subject 1 is, for example, a sample of a tissue slice, a cell, or a biopolymer such as a chromosome, but is not limited to those.

The stage 101 is movable in three axis directions which are perpendicular to each other. In other words, the stage 101 is movable in an X axis direction and a Y axis direction which are perpendicular to each other in a plane direction of the placement surface 109. Further, the stage 101 is movable in a Z axis direction along an optical axis of an objective lens 102A of the optical system 102.

The subject 1 is fixed in position by a predetermined fixation method by being disposed between a glass slide SG and a cover glass CG and is subjected to stain as necessary. The stain method includes general stain methods such as HE (hematoxylin eosin) stain, Giemsa stain, and Papanicolaou stain, and fluorescence stain such as FISH (Fluorescence In Situ Hybridization) and an enzyme labeled antibody method. The fluorescence stain is performed to mark a specific target in the subject 1, for example.

The optical system 102 is provided above the stage 101 and is constituted of the objective lens 102A, an imaging lens 102B, a dichroic mirror 102C, an emission filter 102D, and an excitation filter 102E. The light source 104 is formed of an LED (light emitting diode) or the like.

The objective lens 102A and the imaging lens 102B scale up an image of the subject 1 obtained by the illumination lamp 103 at a predetermined magnification and cause the scaled-up image to be formed on an image pickup surface of the optical sensor 105.

The excitation filter 102E causes only light having an excitation wavelength that excites a fluorochrome out of light emitted from the light source 104 to pass therethrough to generate excitation light. The dichroic mirror 102C causes the incident excitation light that passes through the excitation filter to be reflected thereon to guide the light to the objective lens 102A. The objective lens 102A collects the excitation light to the subject 1.

In the case where the fluorescence stain is performed on the subject 1 fixed to the glass slide SG, the fluorochrome emits light by the excitation light. The light (color producing light) obtained by the light emission passes through the dichroic mirror 102C via the objective lens 102A and reaches the imaging lens 102B via the emission filter 102D.

The emission filter 102D absorbs light (outside light) except the color producing light scaled up by the objective lens 102A. An image of the color producing light obtained after the outside light is lost is scaled up by the imaging lens 102B and formed on the optical sensor 105.

The illumination lamp 103 is provided below the stage 101 and irradiates the subject 1 placed on the placement surface 109 with illumination light through an opening (not shown) formed on the stage 101.

As the optical sensor 105, a CCD (Charge Coupled Device), a CMOS (Complementary Metal Oxide Semiconductor), or the like is used. The optical sensor 105 may be provided integrally with the digital microscope 100 or may be provided in an image pickup apparatus (such as a digital camera) which is separated from the digital microscope 100 but can be coupled thereto.

The optical sensor control unit 106 controls the optical sensor 105 on the basis of a control command from the control PC 200. Further, the optical sensor control unit 106 takes in an output from the optical sensor 105 and transfers the output to the control PC 200.

The light emission control unit 107 performs control relating to exposure, such as an exposure time period and an emission intensity of the illumination light 103 or the light source 104, on the basis of the control command from the control PC 200.

The stage control unit 108 controls the movement of the stage 101 in the XYZ axis directions on the basis of the control command from the control PC 200.

The control PC 200 is an apparatus having typical computer hardware elements. The control PC 200 controls the digital microscope 100 and is capable of storing images of the subject 1 which are taken by the digital microscope 100 as digital image data in a predetermined format.

The control PC 200 has, as a functional structure attained with the use of the typical computer hardware elements, a hardware control unit 201, a sensor signal developing unit 202, a matching processing unit 203, and an image output unit 204. Those units are attained by a program for operating the control PC 200. Alternatively, dedicated hardware may be used as appropriate.

The sensor signal developing unit 202 generates digital image data from a sensor signal taken from the optical sensor 105 through the optical sensor control unit 106. The digital image data generated is supplied to the matching processing unit 203.

In this embodiment, the image of the subject 1 is taken so that a plurality of image taking areas are overlapped with each other, thereby generating a plurality of partial images. Specifically, sensor signals relating to the plurality of partial images are output to the sensor signal developing unit 202. Then, the sensor signal developing unit 202 generates image data of the plurality of partial images. The image data of the partial images generated is supplied to the matching processing unit 203. In the following description, the term “image” includes the image data of the image.

The matching processing unit 203 has an offset value calculation unit 205 and a reliability calculation unit 206. The offset value calculation unit 205 calculates an offset value for each of two partial images adjacent to each other out of the plurality of the partial images. In this embodiment, the offset value is calculated as relative positional displacement information of the two partial images adjacent to each other.

The reliability calculation unit 206 calculates a reliability of the offset value calculated for each of two partial images.

The image output unit 204 converts digital image data supplied from the sensor signal developing unit 202 into a file format which is easily processed on a computer, such as JPEG (Joint Photographic Experts Group) and Tiff (Tagged Image File Format) and stores the data as a file in a storage unit 308 or the like.

The hardware control unit 201 controls the optical sensor control unit 106, the light emission control unit 107, and the stage control unit 108 in the digital microscope 100.

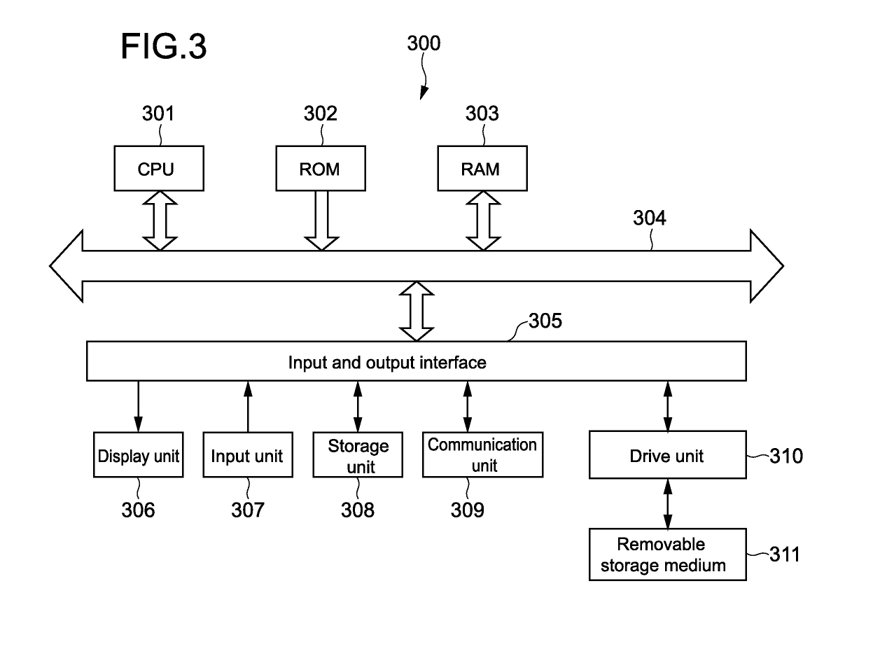

FIG. 3 is a schematic diagram showing a hardware structural example of the server 300 serving as the information processing apparatus according to this embodiment. In this embodiment, as the server 300, a computer such as a PC is used.

The server 300 is provided with a CPU (Central Processing Unit) 301, a ROM (Read Only Memory) 302, a RAM (Random Access Memory) 303, an input and output interface 305, and a bus 304 which connects those to each other.

To the input and output interface 305, a display unit 306, an input unit 307, the storage unit 308, a communication unit 309, a drive unit 310, and the like are connected.

The display unit 306 is a display device that uses liquid crystal, an EL (Electro-Luminescence), a CRT (Cathode Ray Tube), or the like.

The input unit 307 is a pointing device, a keyboard, a touch panel, or another operation apparatus. In the case where the input unit 307 includes the touch panel, the touch panel can be integrated with the display unit 306.

The storage unit 308 is a non-volatile storage device, and is an HDD (Hard Disk Drive), a flash memory, or another solid-state memory.

The drive unit 310 is a device capable of driving a removable recording medium 311 such as an optical recording medium, a floppy (registered trademark) disk, a magnetic recording tape, and a flash memory. In contrast, the storage unit 308 is often used as a device which drives a non-removable recording medium mainly and is equipped to the server 300 in advance.

The communication unit 309 is a modem, a router, or another communication apparatus for communicating with another device, which is capable of being connected with a LAN (Local Area Network), a WAN (Wide Area Network), or the like. The communication unit 309 may perform wire or wireless communication. The communication unit 309 is often used independently of the server 300.

The information processing by the server 300 having the hardware structure described above is achieved by software stored in the storage unit 308, the ROM 302, or the like and the hardware resources of the server 300 in cooperation with each other. Specifically, the information processing is achieved when the CPU 301 loads a program which constitutes the software and stored in the storage unit 308, the ROM 302, or the like to the RAM 303 and executes the program. The program is installed to the server 300 via a recording medium, for example. Alternatively, the program may be installed via a global network or the like.

In this embodiment, the CPU 301 achieves a determination unit, a generation unit, and an instruction input unit. Alternatively, the input and output interface 305 and the CPU 301 achieve the instruction input unit. However, the structure is not limited thereto. Dedicated hardware may be used as appropriate.

Further, the storage unit 308, the ROM 302, or the like achieves a storage unit according to this embodiment. The storage unit stores information relating to the offset value, the reliability, the plurality of partial images, and the like.

The viewer 400 is used to view various images generated by the server 300. As the viewer 400, a PC having a display is used, for example. The viewer 400 according to this embodiment has an input unit (not shown) which is capable of being operated by a user. The user can input various operations by using the input unit while visually confirming an image displayed on the display.

In this embodiment, via the network such as the LAN and the WAN, the control PC 200, the server 300, and the viewer 400 are connected to each other. Then, for example, images, various pieces of information, and the like are transmitted and received among the devices. Further, an instruction in accordance with the operation by the user which is input to the input unit (input unit 307) of each device is transmitted and received among the devices.

It should be noted that the control PC 200, the server 300, and the viewer 400 may be connected with each other without using the network such as the LAN. A connection form of the devices can be set as appropriate.

(Operation of Image Processing System)

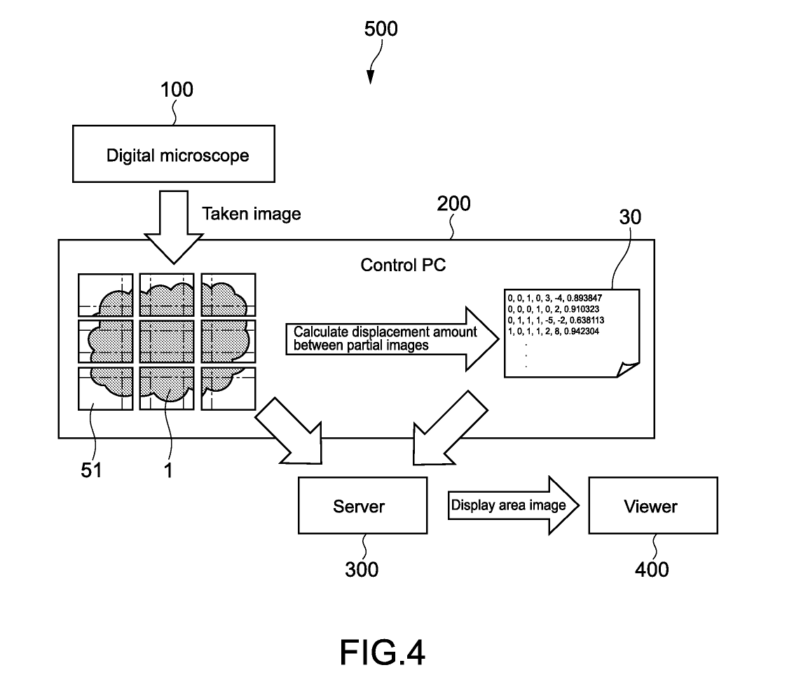

A description will be given on an operation of the image processing system 500 according to this embodiment. FIG. 4 is a schematic diagram showing an outline of the operation of the image processing system 500 according to this embodiment.

The control PC 200 controls the digital microscope 100, and an image of the subject 1 is taken so that a plurality of image taking areas 50 are overlapped with each other, thereby generating a plurality of partial images 51. Further, the control PC 200 calculates the offset value as relative positional displacement information of two partial images 51 adjacent to each other for each of two partial images 51 adjacent to each other out of the plurality of partial images 51.

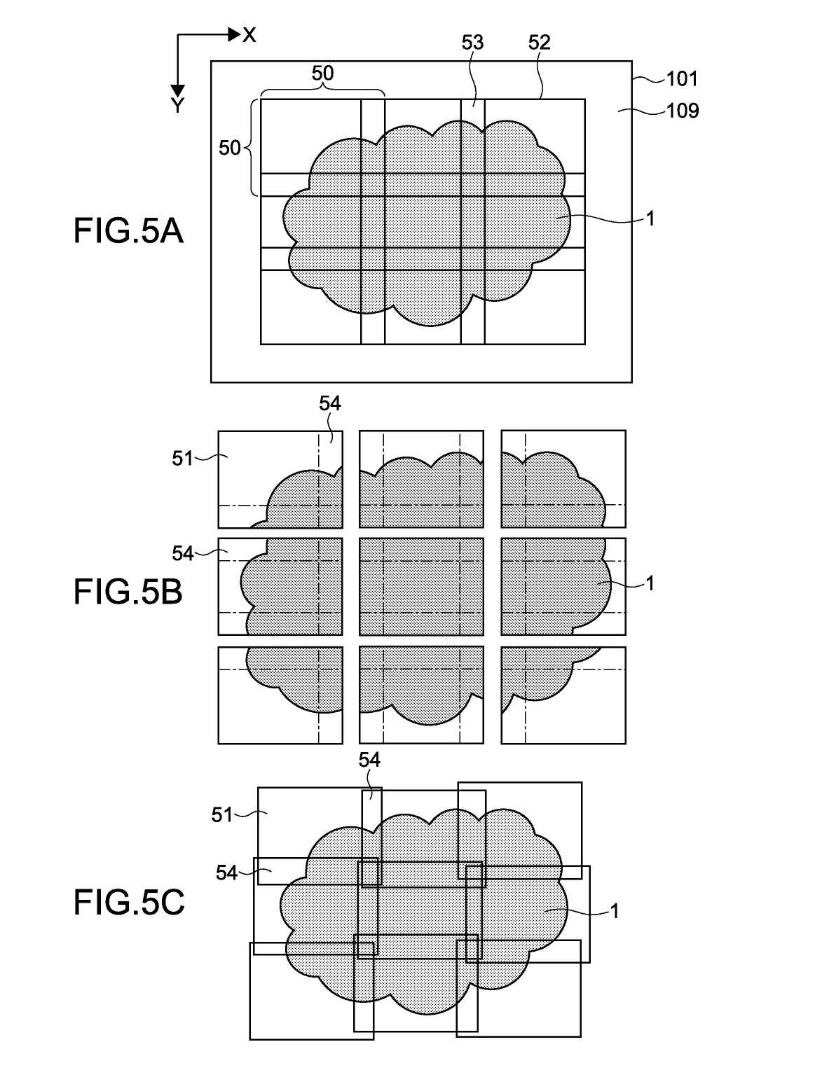

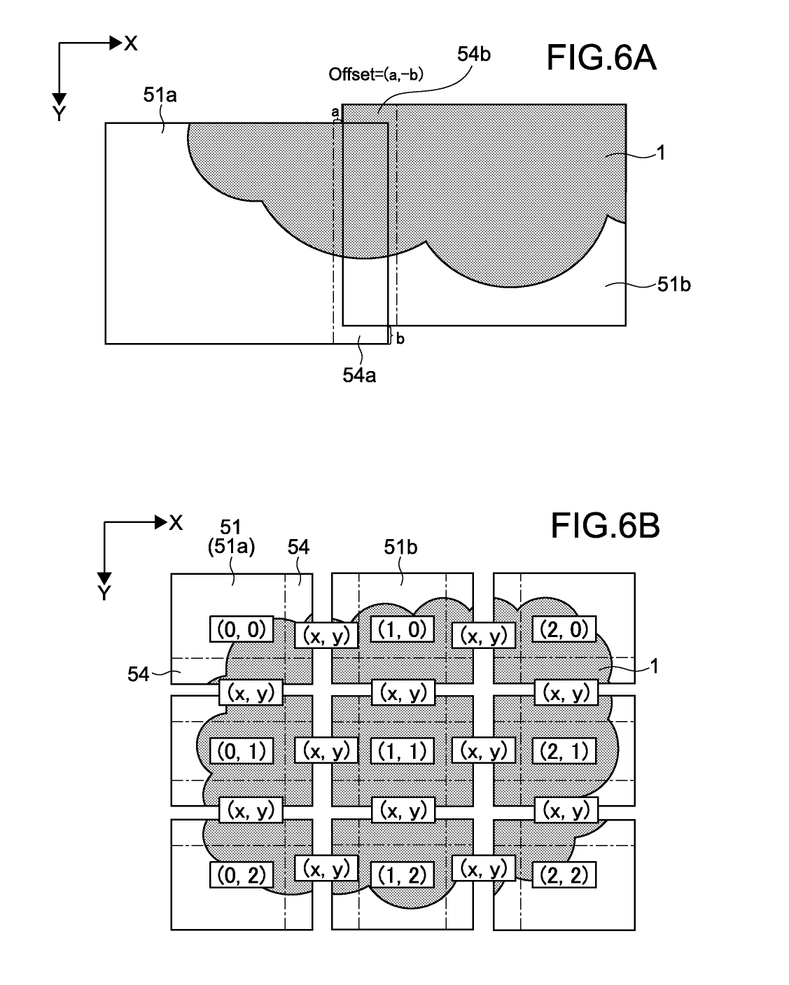

FIGS. 5 and 6 are diagrams for explaining a generation process of the plurality of partial images 51 and the offset value by the control PC 200.

FIG. 5A is a diagram showing a movement of an image taking area 50 with respect to the subject 1 on the placement surface 109 of the stage 101. An entire area 52 as an image taking target on the placement surface 109 of the stage 101 has a rectangular shape in general. The image taking area 50 which is smaller than the entire area 52 is one image taking range. The image taking area 50 is moved in the X axis direction and the Y axis direction selectively with respect to the entire area 52, and images of the image taking area 50 are repeatedly taken each time, thereby taking an image of the entire area 52.

The stage 101 and the optical system 102 only have to be movable in the XYZ axis directions relative to each other. In this embodiment, the optical system 102 is fixed in position, and the stage 101 is movable in the XYZ directions. However, reversely, the stage 101 may be fixed in position, and the optical system 102 may be movable in the XYZ directions selectively.

The size of the image taking area 50 and amounts of movement thereof in the X axis direction and the Y axis direction are set so that a predetermined overlap 53 is obtained between the image taking areas 50 adjacent to each other in each of the X axis direction and the Y axis direction. For example, the amount of one movement of the image taking area 50 in the X axis direction is approximately 60 to 95% of the size of the image taking area 50 in the X axis direction. Further, the size of the overlap 53 in the X axis direction between the image taking areas 50 adjacent to each other in the X axis direction is approximately 5 to 40% of the size of the image taking area 50 in the X axis direction. Those proportions may be applied to the Y axis direction of the image taking area 50 in the same way.

As described above, the image is taken with respect to the subject 1 so that the plurality of image taking areas 50 are overlapped with each other, thereby generating the plurality of partial images 51 as shown in FIG. 5B. The plurality of partial images 51 each have connection areas 54 corresponding to the overlaps 53 of the image taking areas 50.

In the example shown in FIG. 5, images of nine image taking areas 50 are taken, and nine partial images 51 are generated. However, the number of image taking areas 50, the size thereof, the order of image taking, the size of the overlap 53, and the like are not limited and may be set as appropriate. That is, the number of partial images 51 to be generated, the size thereof, and the like can also be set as appropriate.

For example, in the field of medicine, pathology, or the like, there is a case where a scaled-up image of a cell, a tissue, or the like of a living body, which is obtained by a digital microscope, is generated by a stitching technique. In this case, 2400 partial images 51 in total, in which 40 images and 60 images are arranged in the X axis direction and the Y axis direction, respectively, may be generated.

As shown in FIG. 5C, the matching processing unit 203 of the control PC 200 performs a matching process for each of two partial images 51 adjacent to each other. As a result, the offset value calculation unit 205 calculates the offset value.

For example, due to a movement error of the stage 101, an error of image taking accuracy, or the like, an error may be generated in a relative positional relationship among the plurality of partial images 51. That is, the relative positional relationship among the plurality of partial images 51 may be displaced as compared to the relative positional relationship among the plurality of image taking areas 50 shown in FIG. 5.

Accordingly, as shown in FIG. 5C, to appropriately connect the plurality of partial images 51 to each other, the positions of the plurality of partial images 51 relative to each other have to be adjusted as appropriate. To attain this, the offset value, which is relative positional displacement information of the two partial images 51 adjacent to each other, is calculated.

In this embodiment, the matching process is performed with respect to the connection areas 54 held by the two adjacent partial images 51, respectively, and on the basis of the result, the offset value is calculated. In the matching process in this embodiment, a brightness value is calculated for each pixel of the connection areas 54, and a correlation coefficient is calculated on the basis of the brightness value. However, the matching process is not limited to this and may be performed by calculating a square of a difference between the brightness values for each pixel of the connection regions 54. Alternatively, a frequency component of the connection areas 54 may be used. In addition, various algorisms used for an image pattern matching can be used.

FIG. 6A is a schematic diagram showing two partial images 51a and 51b which are connected in an appropriate positional relationship on the basis of the offset value calculated. For example, in the case where there is no displacement in the relative positional relationship between the partial images 51a and 51b, connection regions 54a and 54b of the two partial images 51a and 51b, respectively, are directly overlapped with each other, thereby appropriately connecting the partial images 51a and 51b to each other. In this case, the offset value is (0, 0).

In the example shown in FIG. 6A, the connection area 54b of the right partial image 51b is displaced in the X axis direction by a (pixel) and in the Y axis direction by −b (pixel) with respect to the connection area 54a of the left partial image 51a and overlapped therewith. Then, on the position, the two partial images 51a and 51b are appropriately connected to each other. That is, in this example, the offset value of (a, −b) is calculated.

It should be noted that in this embodiment, a coordinate system is determined with a point at the upper left of the disposed partial images 51a and 51b as an origin. In FIG. 6A, a direction from left to right corresponds to a positive direction of the X coordinate, and a direction from top to bottom corresponds to a positive direction of the Y coordinate. The offset value is represented by signed integers on the basis of the coordinate system. However, the coordinate system can be set as appropriate.

As shown in FIG. 6B, in this embodiment, the offset value (x, y) is calculated for each of two adjacent partial images 51 out of the plurality of partial images 51. The offset value calculated is transmitted to the server 300 along with the plurality of partial images 51.

Further, in this embodiment, the reliability calculation unit 206 calculates the reliability of the offset value calculated for each of two partial images 51. In this embodiment, a value of the correlation coefficient calculated in the matching process is used as the reliability.

In the case where the correlation coefficient of the connection areas 54 is high, it is thought that the connection areas 54 are connected with each other with high accuracy. Therefore, in the case where the correlation coefficient value is high, it can be determined that the reliability of the offset value calculated is high. On the other hand, in the case where the correlation coefficient value is low, it can be determined that the reliability of the offset value calculated is low.

It should be noted that the reliability is not limited to the correlation coefficient value. For example, on the basis of the correlation coefficient, a new numerical value may be calculated and used as the reliability. Further, another numerical value relating to the matching process, such as a square of a difference of the brightness values and a standard deviation, may be used as appropriate. The reliability calculated is transmitted to the server 300.

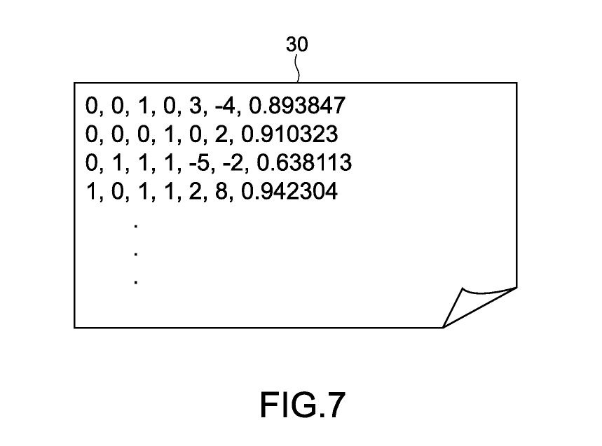

FIG. 7 is a schematic diagram showing an example of a data format of the offset value and the reliability according to this embodiment. Here, the offset value between the adjacent partial images 51a and 51b and the reliability are generated as follows.

To generate the offset value and the reliability, the following elements are necessary.

Identifiers of the partial images 51a and 51b

Amount of displacement (offset value) of the partial images 51a and 51b in each of the X axis direction and Y axis direction

Probability (reliability) of the amounts of displacement of the partial images 51a and 51b

The elements described above can be obtained as follows, for example.

The upper left is set as the origin, and XY coordinates using the size of the partial image 51 as a unit origin are set as the identifier of the partial image 51. In FIG. 6B, on the center of each of the partial images 51, the XY coordinates for identifying the partial images 51 are shown.

A relative displacement amount of the two adjacent partial images 51a and 51b is represented by signed integers (XY coordinates between the partial images shown in the figure).

A correlation value (real number of 0 to 1 (inclusive)) obtained by a pattern matching calculation is set as the probability.

On the basis of the way of thinking described above, the offset value and the reliability can be represented by a text data 30 as shown in FIG. 7. In each of rows of the text data 30 shown in FIG. 7, numbers arranged indicate the following information items in order from the left.

(x coordinate of partial image 51a)

(y coordinate of partial image 51a)

(x coordinate of partial image 51b)

(y coordinate of partial image 51b)

(displacement in X axis direction)

(displacement in Y axis direction)

(Probability of displacement amount)

For example, data shown in the first row indicates that the offset value between the partial image 51a, the coordinates of which are (0, 0), and the partial image 51b, the coordinates of which are (1, 0), shown in FIG. 6B is (3, −4), and the reliability thereof is 0.893847.

As described above, in this embodiment, it is possible to generate the offset value and the reliability as the text data. As a result, it is possible to save a storage content in storing the offset values and the reliabilities.

However, the way of representing the offset value and the reliability is not limited to the case where those are generated as the text data. For example, a table may be generated as data that represents the offset value and the reliability, in which the plurality of partial images 51 are arranged in longitudinal and lateral directions by using identifiers. In addition, it is possible to appropriately set the format of data that represents the offset value and the reliability.

(Operation of Server)

As shown in FIG. 4, the server 300 as the information processing apparatus according to this embodiment receives, from the control PC 200, the plurality of partial images 51 and the text data 30 including the offset values and the reliability information. The data is stored in the storage unit 308 or the like of the server 300. Then, the server 300 generates a display area image on the basis of the pieces of data stored and transmits the image to the viewer 400. The display area image refers to an image of an area displayed on the display of the viewer 400 as an image of the subject 1.

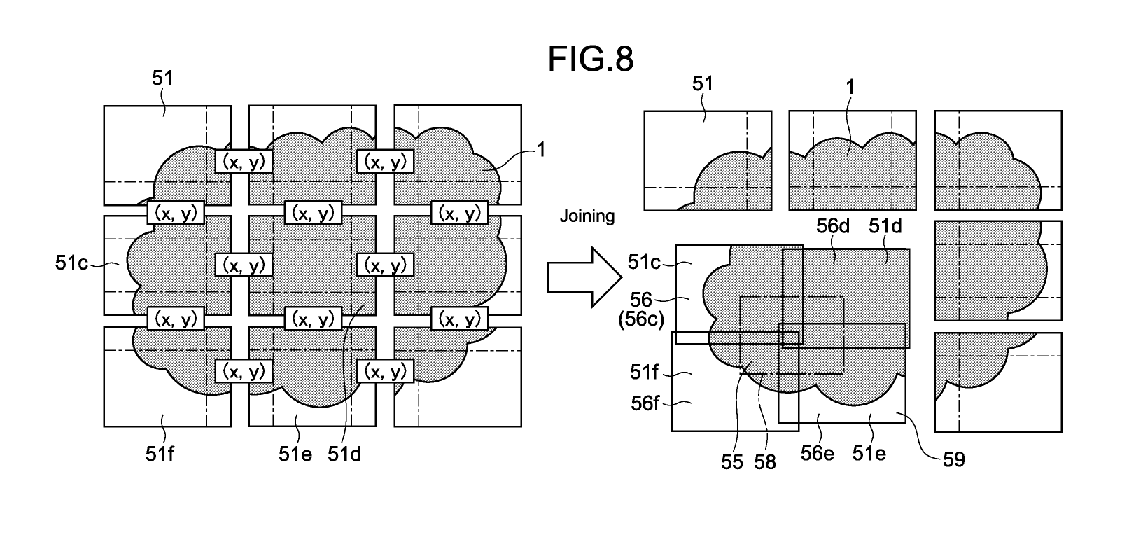

FIG. 8 is a schematic diagram showing the outline of the operation of the server 300 according to this embodiment. In this embodiment, the CPU 301 that functions as the determination unit determines one or more display partial images 56 for generating a display area image 55 from the plurality of partial images 51 stored.

In the example shown in FIG. 8, in order to generate the display area image 55, it is necessary to connect partial images 51c to 51f to each other. Therefore, the partial images 51c to 51f are determined as display partial images 56c to 56f.

Next, by the CPU 301 that functions as the generation unit, the plurality of display partial images 56c to 56f determined are connected to each other on the basis of the offset values stored in the storage unit 308 or the like. As a result, the display area image 55 is generated. That is, in this embodiment, the display partial images 56 are determined as appropriate in accordance with an area to be displayed by the viewer 400 and the display area image 55 is generated.

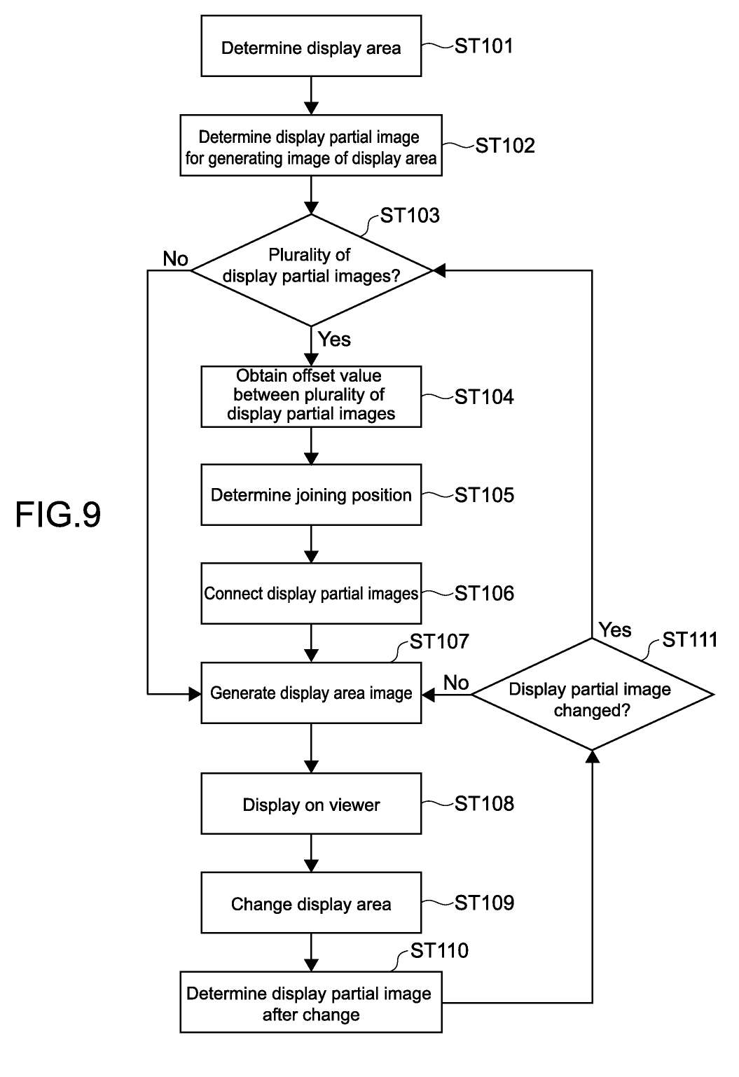

FIG. 9 is a flowchart showing an operation example of the server 300. First, the display area to be displayed by the viewer 400 is determined (Step 101). Then, the display partial images 56 for generating the display area image 55 are determined (Step 102).

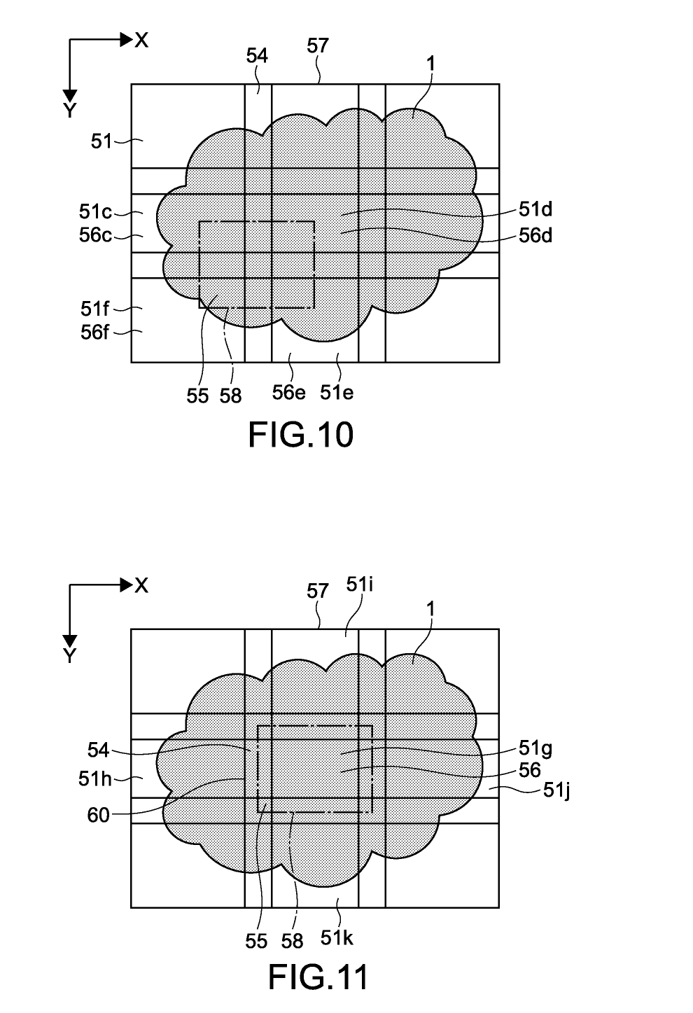

FIG. 10 is a diagram for explaining a determination process of the display area and the display partial images 56. In this embodiment, on the basis of a reference image 57 shown in FIG. 10, the position of a display area 58 is calculated. The reference image 57 refers to an image obtained by causing the plurality of partial images 51 to overlap each other on the connection areas 54. At this time, the offset value is not taken into consideration, and the connection areas 54 held by the partial images 51 are overlapped as they are (i.e., overlapped with the offset value being (0, 0)).

Further, it is unnecessary to perform an image synthesis process, and the positions of the partial images 51 and the positions of the connection regions 54 in the reference image 57 only have to be obtained. For example, a size of the display area 58 and coordinates of the center in the reference image 57 are set. At this time, it is only necessary that the partial images 51 included in the display area 58 can be determined. It should be noted that the coordinates used are not limited to the coordinates of the center of the display area 58, and coordinates of the upper left of the display area 58 may be used, for example.

In the example shown in FIG. 10, on the basis of the size of the display area 58 and the coordinates of the center position in the reference image 57, the partial images 51c to 51f are determined as the partial images 51 included in the display area 58. The partial images 51c to 51f are determined as the display partial images 56c to 56f.

It should be noted that the display area 58 may be subjected to default setting when the display area image 55 is displayed first by the viewer 400 and may be moved in accordance with an instruction received by the input unit of the viewer 400 or the input unit 307 of the server 300. For example, through a drag operation with the use of a mouse or the like or an input with the use of an arrow key of a controller, the coordinates of the display area 58 are changed.

It is determined whether there are a plurality of display partial images 56 or not (Step 103). As shown in FIG. 10, in the case where the plurality of display partial images 56c to 56f are determined (Yes in Step 103), the offset values between the plurality of display partial images 56c to 56f are read from the storage unit 308 or the like (Step 104).

On the basis of the offset values read, joining positions of the plurality of display partial images 56c to 56f are determined (Step 105). In this embodiment, on the basis of the offset values and the reliabilities of the offset values, the joining positions are determined.

For example, in the example shown in FIG. 10, four offset values and reliabilities thereof are obtained among four display partial images 56c to 56f The four offset values are used in descending order of the reliability to determine the joining positions.

For example, on the basis of the offset value having the highest reliability, two display partial images 56 (e.g., 56c and 56d) to be connected with the offset value are arranged. Then, by using the offset value having the second highest reliability, the third display partial image 56 (e.g., 56e) is disposed, and finally the fourth display partial image 56 (e.g., 56f) is disposed.

Alternatively, after the two display partial images 56 (e.g., 56c and 56d) are arranged, the remaining two display partial images 56 (e.g., 56e and 56f) are arranged in some cases. Then, the offset value having the third highest reliability may be used to dispose the four display partial images 56c to 56f.

The plurality of display partial images 56c to 56f, the joining positions of which are determined, are connected to each other (Step 106). Then, from an image 59 obtained by the connection (see, FIG. 8), the display area image 55 is generated (Step 107). The display area image 55 thus generated is transmitted to the viewer 400 and displayed by the viewer 400 (Step 108). At this time, image data of the display area image 55 in the connection image 59 may be transmitted. Alternatively, the image data of the connection image 59 may be transmitted, and the display area image 55 may be displayed by the viewer 400 as appropriate. In this case, the generation of the connection image 59 corresponds to the generation of the display area image 55.

In Step 103, in the case where it is determined that the number of display partial images 56 is not two or more but one (No in Step 103), the display area image 55 is generated on the basis of the one display partial image 56 (Step 107).

FIG. 11 is a diagram for explaining the number of the display partial images 56. In the example shown in FIG. 11, the display area 58 is disposed on the center of the reference image 57. The display area 58 includes a partial image 51g on the center and four partial images 51h to 51k adjacent thereto on the upper, lower, left, and right sides thereof.

Meanwhile, the entire display area 58 is included in the partial image 51g on the center. In this case, the display area image 55 can be generated by the partial image 51 on the center, so it is only necessary to determine the one partial image 51g on the center as the display partial image 56. As a result, the display area image 55 which does not include a connection part and thus has high accuracy is generated.

As described above, there is a case where it is possible to generate the display area image 55 by using a part of the partial images 51 out of the partial images 51 included in the display area 58. In such a case, it is only necessary to determine the display partial image 56 so as to be small in number, for example. As a result, the display area image 55 having less portions which are subject to the stitching process and thus having high accuracy is generated.

It should be noted that in the case where the reliability or the like of the offset value is low, and the display area image 55 having high accuracy is not generated with a small number of display partial images 56, the number of display partial images 56 may be increased. That is, in consideration of the number of connection portions, the reliabilities of the offset values, and the like in a comprehensive manner, the number of display partial images 56 may be set as appropriate. To perform such a setting, a setting of a threshold value for the reliability is conceived, for example.

Alternatively, on the basis of the position of the display area 58, the number of display partial images 56 may be set as appropriate. For example, in the example shown in FIG. 11, in the case where the display area 58 is positioned within a predetermined distance from an edge 60 of the partial image 51g on the center (case of being close to the edge 60), the adjacent partial image 51 having the connection area 54 including the edge 60 may also be determined as the display partial image 56. As a result, the display area image 55 having high accuracy is generated.

In the case where the display area 58 is changed in accordance with the instruction or the like by the user, the process of Step 109 and subsequent thereto is performed. When the display area 58 is changed in Step 109, the display partial image 56 for generating the display area image 55 after the change is determined (Step 110). The determination process may be performed almost in the same way as Step 102.

It is determined whether the display partial image 56 as a determination result is changed or not (Step 111). For example, in the case where a movement or the like of the display area 58 is small, it is possible to generate the display area image 55 after the change on the basis of the connection image 59 of the display partial image 56 for generating the display area 58 before the change. In such a case, it is determined that the display partial image 56 is not changed (No in Step 111), and on the basis of the connection image 59 generated before the change, the display area image 55 after the change is generated (Step 107).

In the case where it is determined that the display partial image 56 is changed (Yes in Step 111), the process returns to Step 103, and the process described above is carried out. That is, in the case where there are a plurality of display partial images 56 after the change, those images are connected as appropriate to generate the display area image 55. In the case where there is one display partial image 56 after the change, the display area image 55 is generated on the basis of the display partial image 56.

As described above, in the server 300 serving as the information processing apparatus according to this embodiment, the plurality of partial images 51 and the offset values calculated for each of two partial images 51 adjacent to each other are stored. Further, one or more display partial images 56 for generating the display area image 55 are determined. In the case where the plurality of display partial images 56 are determined, the plurality of display partial images 56 are synthesized on the basis of the offset values to generate the display area image 55. In this way, because the display area image 55 is generated as appropriate in accordance with the area displayed as the image of the subject 1, it is possible to sufficiently suppress the accumulation of the displacement between the partial images 51 adjacent to each other.

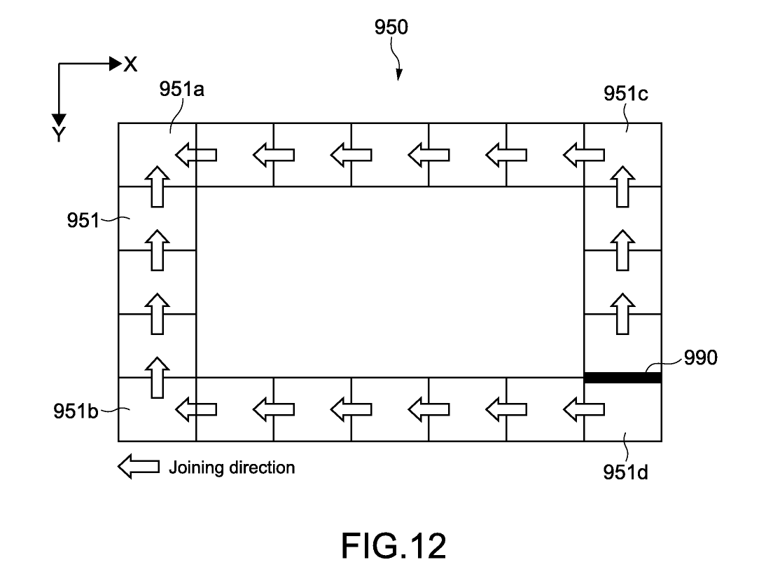

FIG. 12 is a diagram for explaining a method of generating a display area image cited as a comparative example. In the image generation method cited as the comparative example, a plurality of partial images 951 are connected to each other by a control PC on the basis of offset values. Then, one large image 950 is generated and transmitted to a server. In the server, on the basis of a position of a display area, a display area image is generated from the large image 950, and the display area image is transmitted to a viewer.

As shown in FIG. 12, in the case where the large image 950 is generated, the displacement between the partial images 951 connected is accumulated, and ultimately a large displacement may be generated. That is, although the partial images 951 are connected on the basis of the offset value, due to the accuracy or the like of the matching process or the like for calculating the offset value, the displacement may be generated by any means. Consequently, the fine displacement between the partial images 951 is accumulated.

For example, as shown in FIG. 12, the plurality of partial images 951 are sequentially connected downward (in the positive Y axis direction) with a partial image 951a at the upper left as a reference. When a partial image 951b positioned on the lowermost side is connected, the plurality of partial images 951 are sequentially connected from the partial image 951b rightward (in the positive X axis direction).

Meanwhile, the plurality of partial images 951 are sequentially connected rightward (in the positive X axis direction) with the partial image 951a at the upper left as the reference. When a partial image 951c positioned on the right end side is connected, the plurality of partial images 951 are sequentially connected downward (in the positive Y axis direction) from the partial image 951c.

As described above, in the case where the plurality of partial images 951 are connected to each other, the large displacements may be accumulated on the route on which the partial image 951b is connected and on the route on which the partial image 951c is connected, respectively.

In this case, in the case where a partial image 951d at the lower right is connected, if the partial image 951d is connected to the partial image 951 on the left side thereof, a large displacement 990 is generated between the partial image 951d and the partial image 951 on the upper side thereof. On the other hand, if the partial image 951d at the lower right is connected to the partial image 951 on the upper side thereof, the large displacement is generated between the partial image 951d and the partial image 951 on the left side thereof.

As described above, in the field of medicine or the like, there is the case where 2400 partial images are connected. In this case, the displacement generated by causing the fine displacements to be accumulated is highly likely to be significant.

The large displacement may hinder the image of the subject from being appropriately displayed in the lower right part (part where the partial image 951d is connected) of the large image 950. This may probably result in a misdiagnosis or the like in the field of medicine, for example.

Further, the large image 950 is an image obtained by synthesizing the plurality of partial images 951, so it may be impossible to correct the large displacement 990 as necessary when the lower right part is displayed.

In contrast, in this embodiment, in accordance with the position of the display area 58, the display partial image 56 is determined as appropriate, and the display area image 55 is generated as appropriate. The number of display partial images 56 determined can be sufficiently reduced as compared to the total number of partial images 51, although the number thereof depends on the size of the partial image 51, the size of the display area 58, or the like. As a typical example, four display partial images 56 can generate the display area image 55.

Thus, it is possible to prevent the accumulation of the fine displacement between the partial images 51 and the generation of the large displacement. As a result, the display area image 55 with high accuracy is displayed, and therefore it is possible to prevent the misdiagnosis or the like.

Further, when the large image 950 shown in FIG. 12 is generated, the plurality of partial images 951 are arranged on the basis of the offset value, and areas used as the large image 950 are cut out of the partial images 951. Then, the cut-out areas are coupled with each other. Accordingly, to make it possible to generate the display area image from one partial image 951, the display area has to be included in the cut-out areas.

In contrast, in this embodiment, if the display area 58 is included in one partial image 51 having the connection area 54, the one partial image 51 is determined to be the display partial image 56, and the display area image 55 can be generated therefrom. That is, in this embodiment, as compared to the image generation method in the comparative example, the range of the display area image 55 which can be generated from one partial image 51 is large. As a result, even the display area image generated by connecting the plurality of partial images 951 (cut-out areas) in the image generation method of the comparative example may be able to be generated from one display partial image 56. Thus, it is possible to generate a large number of display area images 55 having no connection part with high accuracy.

Further, in this embodiment, in Steps 105 and 106 of FIG. 9, on the basis of the reliability of the offset value, the plurality of display partial images 56 are connected to each other. As a result, it is possible to generate the display area image 55 with high accuracy.

For example, a method of setting an optimal order in which the plurality of partial images 951 are connected by using the reliability at the time when the large image 950 shown in FIG. 12 is generated may be conceived. To achieve the method, however, it is necessary to read all the reliabilities between the partial images 951 and calculate the optimal order in which all the partial images 951 are connected. As a result, a large burden is put on the processing resources such as the CPU and the RAM of the server, which delays the processing speed.

In contrast, in this embodiment, the number of display partial images 56 connected is small, so it is possible to easily perform the connection process with the use of the reliability.

### Second Embodiment

A description will be given on an information processing apparatus according to a second embodiment of the present disclosure. In the following, the description on the same structures and operations as the image processing system 500 of the above embodiment will be omitted or simplified.

In the case where the display partial image as a determination result is changed, a server serving as the information processing apparatus according to this embodiment uses a connection result of the plurality of display partial images before being changed to connect the plurality of display partial images that have been changed to each other. That is, in the case where it is determined that there are the plurality of display partial images that have been changed, the connection result of the plurality of display partial images before being changed is used, thereby connecting the plurality of display partial images that have been changed to each other.

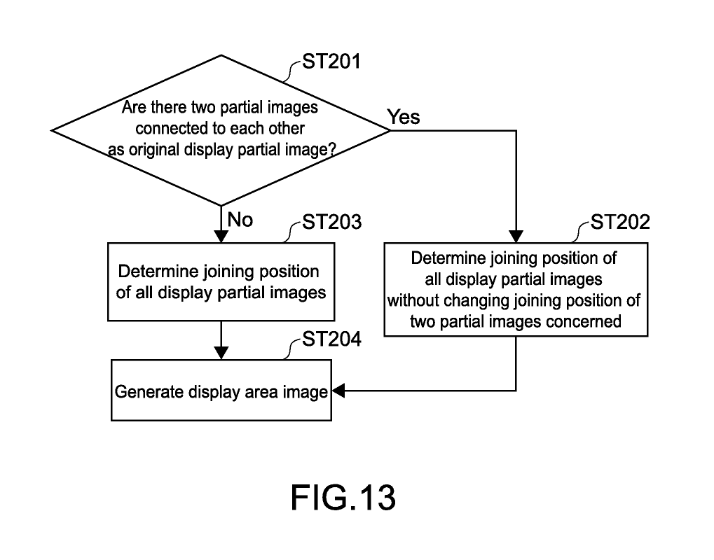

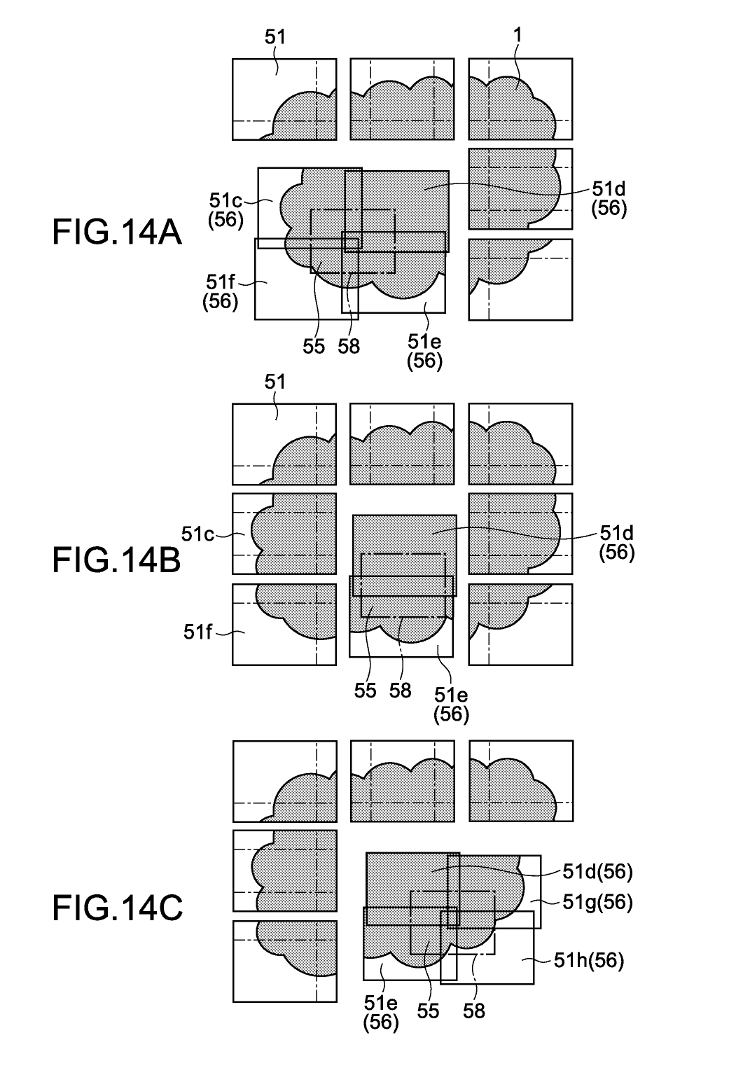

FIG. 13 is a flowchart showing an operation example of the server, in which the operation from Yes in Step 103 to Step 108 of the flowchart shown in FIG. 9 is shown. FIG. 14 are schematic diagrams for explaining the operation example shown in FIG. 13.

It is determined whether the plurality of display partial images 56 changed include two partial images 51 connected to each other as original display partial images 56 (Step 201). For example, the assumption is made that the display area 58 is changed from a position shown in FIG. 14A to a position shown in FIG. 14B, and along with this, the partial images 51 determined as the display partial images 56 are also changed from four partial images 51c to 51f to two partial images 51d and 51e.

At this time, it is determined whether the display partial images 56 changed include two partial images 51 connected to each other as the original display partial images 56. The partial images 51d and 51e shown in FIG. 14B are connected to each other as the original display partial images 56 (Yes in Step 201). Then, the process proceeds to Step 202.

In Step 202, joining positions of all the display partial images 56 are determined without changing the joining position of the two partial images 51d and 51e. In the example shown in FIG. 14B, the joining position of the partial images 51d and 51e is determined. At this time, the joining position at the time when the display area image 55 shown in FIG. 14A is generated is used without being changed. That is, before and after the change of the display area 58, the joining position of the partial images 51d and 51e is not changed.

For example, in FIG. 14A, when the four partial images 51c to 51f serving as the display partial images 56 are connected to each other, there is the case where the offset value between the partial images 51d and 51c is not used. For example, the four partial images 51c to 51f are arranged on the basis of other three offset values.

In this case, as shown in FIG. 14B, the display partial images 56 are changed to the partial images 51d and 51e. At this time, the two partial images 51c and 51e are connected to each other on the basis of the offset value between the partial images 51d and 51c. This may result in a change in positional relationship between the partial images 51d and 51e before and after the change of the display area 58.

As a result, for example, when the display area 58 is gradually changed from the state shown in FIG. 14A to the state shown in FIG. 14B, the display area image 55 to be displayed by the viewer may be abruptly changed, which may cause a trouble in an observation or the like of the subject 1 by the user.

Accordingly, in this embodiment, in the case where the plurality of display partial images 56 changed include the two partial images 51 connected to each other as the original display partial images 56, the joining position of the two partial images 51 is set so as not to be changed. That is, by using the connection result of the plurality of display partial images 56 before being changed, the plurality of display partial images 56 that have been changed are connected to each other. As a result, it is possible to prevent the problem mentioned above and carry out the movement or the like of the display area 58 with high accuracy.

The same holds true for the case where the display area 58 is changed from the state shown in FIG. 14B to the state shown in FIG. 14C. In FIG. 14C, the partial images 51d, 51e, and 51g and a partial image 51h are determined as the display partial images 56. Out of those partial images, the joining position of the partial images 51d and 51e is not changed. For the other partial images 51g and 51h, the joining position thereof is calculated as appropriate on the basis of the offset value, the reliability, or the like.

For example, the assumption is made that the display area 58 is moved to a center position shown in FIG. 11 from the position shown in FIG. 14A and then moved to a position shown in FIG. 14C. In this case, the four display partial images 56 shown in FIG. 14C does not include the images connected as the original display partial images 56 (No in Step 201), so the process proceeds to Step 203.

In Step 203, the joining positions of the four display partial images 56 are determined. At this time, the joining positions of the four display partial images 56 are determined as appropriate on the basis of the offset values, the reliabilities, or the like therebetween.

### Third Embodiment

A description will be given on an information processing apparatus according to a third embodiment of the present disclosure.

In the above embodiment, as explained in Step 104 of the flowchart of FIG. 9, the offset values among the plurality of display partial images are obtained. On the basis of the offset values, the display partial images are connected to each other.

In this embodiment, the offset value between the display partial image and the partial image which is not determined as the display partial image is used as appropriate, thereby connecting the plurality of display partial images. Thus, the display area image is generated.

For example, the assumption is made that the reliability of the offset value of two display partial images adjacent to each other is smaller than a predetermined value. In this case, the offset value between the two display partial images and the partial images which are not determined as the display partial images and are adjacent to the two display partial images is used as appropriate. Thus, the two display partial images are connected to each other. In the following description, the partial image which is adjacent to the display partial image and is not determined as the display partial image is referred to as an adjacent image.

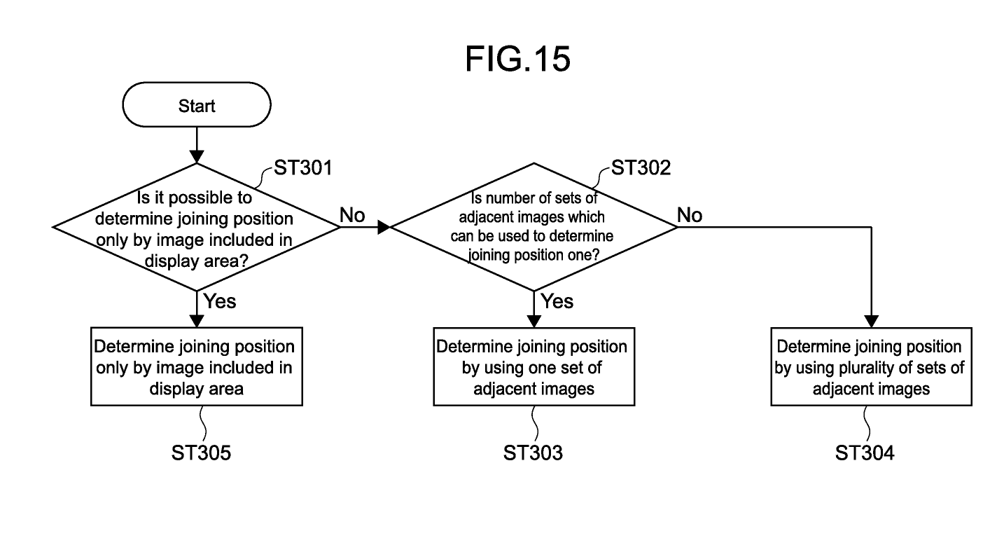

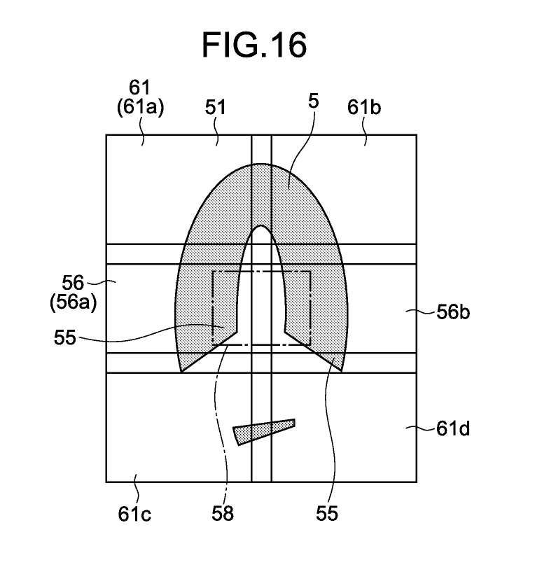

FIG. 15 is a flowchart showing an operation example of a server as the information processing apparatus according to this embodiment. FIG. 16 is a schematic diagram for explaining the operation example shown in FIG. 15.

In this example, an image of a subject 5 having a shape as shown in FIG. 16 is taken with six partial images 51. The display area 58 is set approximately on the center thereof. In this case, in this embodiment, the display area image 55 is generated as follows.

It is determined whether only display partial images 56a and 56b included in the display area 58 can determine the joining position (Step 301). In this embodiment, the determination process is carried out on the basis of the reliability of the offset value between the display partial images 56a and 56b.

As shown in FIG. 16, the subject 5 does not exist between the display partial images 56a and 56b, so the reliability of the offset value between the images is low. In this embodiment, the reliability is smaller than a predetermined threshold value, and thus it is determined that it may be impossible to determine the joining position only by the display partial images 56a and 56b (No in Step 301).

It should be noted that the determination process of Step 301 is not limited to the case of being executed on the basis of the reliability. For example, the determination process may be executed on the basis of existence/nonexistence of the subject 5 displayed between the display partial images 56, a display area of the subject 5, or the like. Alternatively, the determination process of Step 301 may be executed on the basis of an entire shape of the subject 5, the position of the display partial image 56, or the like.

It is determined whether the adjacent images 61 which can be used to determine the joining position between the display partial images 56a and 56b is one set or not (Step 302). The set of adjacent images 61 refers to two adjacent images 61 which are adjacent to each other. In the example shown in FIG. 16, adjacent images 61a and 61b form the set, and adjacent images 61c and 61d form the set.

Whether the set of adjacent images 61 can be used to determine the joining position is determined on the basis of the reliabilities of the offset values between the display partial images 56a and 56b and the sets of adjacent images 61.

In the example shown in FIG. 16, the reliability of the offset value between the display partial image 56a and the adjacent image 61a and the reliability of the offset value between the display partial image 56b and the adjacent image 61b are larger than the predetermined threshold value. Therefore, it is determined that the set of adjacent images 61a and 61b can be used to determine the joining position.

On the other hand, the reliability of the offset value between the display partial image 56a and the adjacent image 61c and the reliability of the offset value between the display partial image 56b and the adjacent image 61d are smaller than the predetermined threshold value. Therefore, it is determined that it may be impossible to use the set of adjacent images 61c and 61d to determine the joining position.

It should be noted that the determination process of Step 302 is also not limited to the case of being executed on the basis of the reliability of the offset value. Further, a threshold value setting method or the like with respect to the set of two adjacent images 61 is also not limited.

The process proceeds to Yes in Step 302. With the use of the adjacent images 61a and 61b, the joining position between the display partial images 56a and 56b is determined (Step 303). As the method therefor, a method of sequentially disposing the images in descending order of the reliability, for example. This method is approximately equal to the method executed in the case where the four images of the display partial images 56a and 56b and the adjacent images 61a and 61b are entirely determined to be the display partial images 56. In addition, any method may be used as a method of using the adjacent images 61a and 61b.

For example, the assumption is made that the threshold value is set to be low in Step 302, and it is determined that the adjacent images 61c and 61d can be used. In this case, the process proceeds to No in Step 302, and the two sets of adjacent images 61, that is, the adjacent images 61a and 61b and the adjacent images 61c and 61d are used. Then, the joining position between the display partial images 56a and 56b is determined (Step 304).

At this time, for example, the reliability between the display partial images 56a and 56b and the adjacent images 61a and 61b and the reliability between the display partial images 56a and 56b and the adjacent images 61c and 61d are compared to each other. Further, the reliability between the adjacent images 61a and 61b and the reliability between the adjacent images 61c and 61d are compared to each other.

In the example shown in FIG. 16, the reliability between the display partial images 56a and 56b and the adjacent images 61a and 61b is higher, and the reliability between the adjacent images 61a and 61b is higher. On the basis of the result, only the adjacent images 61a and 61b may be used to determine the joining position.

It should be noted that in Step 304, the above process is not limited to the process of selecting one set of the adjacent images 61 which are capable of being used to determine the joining position between the display partial images 56a and 56b. A plurality of sets of adjacent images which are determined to be usable may be used as appropriate, and the joining position may be determined as appropriate.

In Step 301, in the case where it is determined that only the display partial images 56a and 56b included in the display area 58 can determine the joining position (Yes in Step 301), the joining position only has to be determined on the basis of the offset value between the two display partial images 56a and 56b (Step 305).

In this way, in the case where the reliability of the offset value between the display partial images 56a and 56b is smaller than the predetermined value, the offset values between the two display partial images 56a and 56b and the adjacent images 61a to 61d may be used as appropriate. As a result, it is possible to generate the display area image 55 with high accuracy.

In addition to this embodiment, the offset value between the display partial images 56a and 56b and the partial image 51 which is not determined as the display partial image may be used as appropriate. As a result, it is possible to generate the display area image 55 with high accuracy.

### Fourth Embodiment

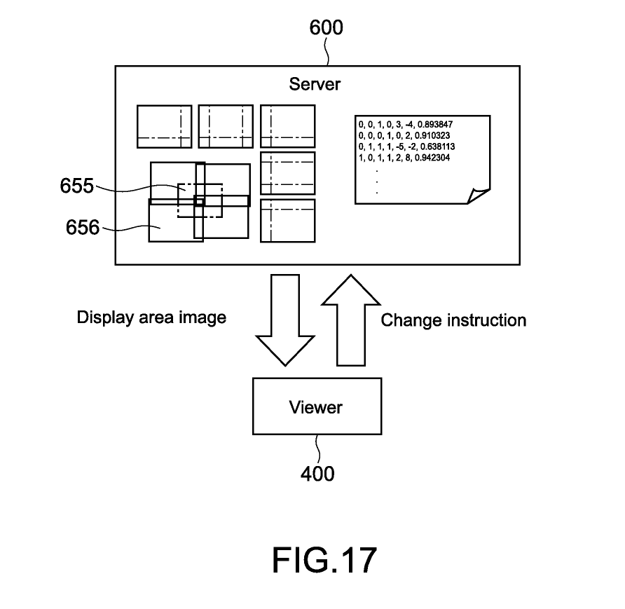

A description will be given on an information processing apparatus according to a fourth embodiment of the present disclosure. FIG. 17 is a schematic diagram showing an outline of an operation of a server 600 as an information processing apparatus according to this embodiment.

In this embodiment, a plurality of display partial images 656 are connected to each other to generate a display area image 655, and the image generated is displayed by the viewer 400. At this time, the user can input an instruction to change a relative position of two display partial images 656 adjacent to each other while visually confirming the display area image 655.

The change instruction which is input from an input unit or the like of the viewer 400 is transmitted from the viewer 400 to the server 600 and is received by a CPU or the like of the server 600. Alternatively, the change instruction may be input from an input unit of the server 600.

The server 600 which has received the change instruction connects again the plurality of display partial images 656 to generate a new display area image 655 on the basis of the change instruction. The display area image 655 is transmitted to the viewer 400 and is displayed on the display thereof.

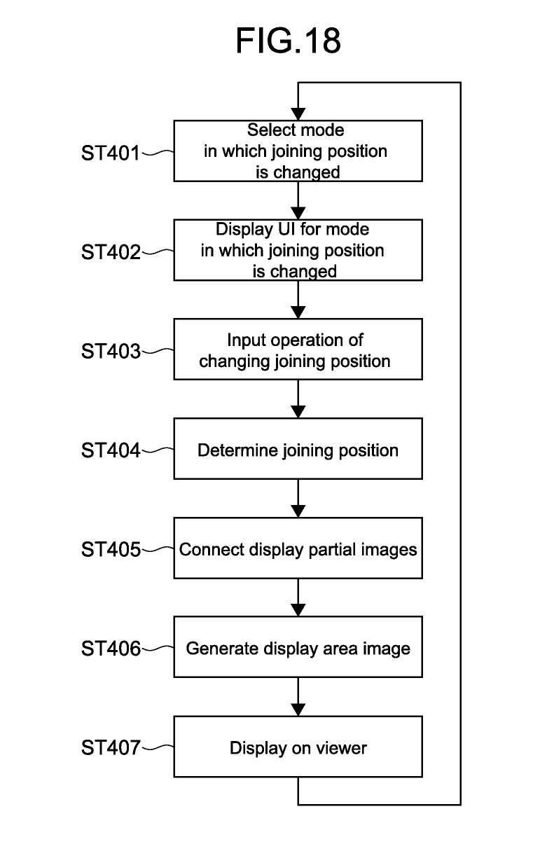

FIG. 18 is a flowchart showing an operation example of the server 600 according to this embodiment.

The user selects a mode of changing the joining position between the two display partial images 656 (Step 401). In this embodiment, the joining position is used as a parameter that indicates the relative position between the two display partial images 656, but is not limited to this.

The server 600 transmits a UI (User Interface) for the change mode of the joining position. Then, the UI is displayed on the display of the viewer 400 (Step 402). On the basis of the UI, the user inputs an operation for changing the joining position (Step 403). As a result, the server 600 receives the change instruction.

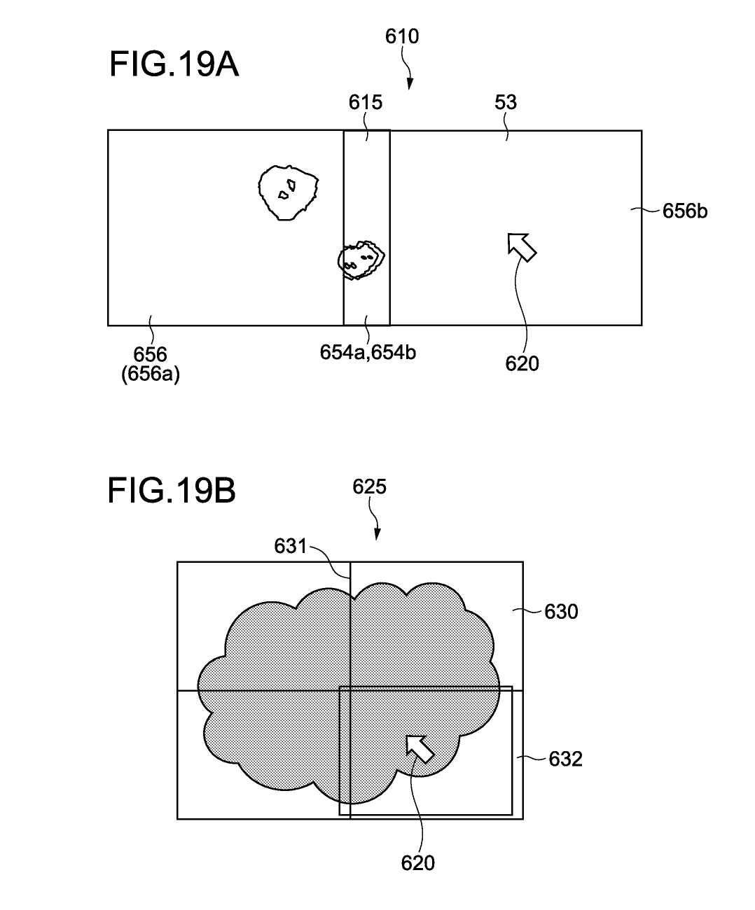

FIG. 19 are schematic diagrams showing an example of the UI for the change mode of the joining position. In a UI 610 shown in FIG. 19A, two display partial images 656a and 656b are displayed in the state where connection areas 654a and 654b thereof are synthesized to each other in a semitransparent manner. The user can change the joining position of the display partial images 656a and 656b while visually confirming a semitransparent image 615 on the center portion as appropriate.

For example, as shown in FIG. 19A, a pointer 620 is displayed on the display of the viewer 400. The pointer 620 is capable of being operated by using an input device or the like such as a mouse. The user moves the pointer 620 onto either one of the display partial images 656. Then, the user performs a drag operation or the like to change the joining position.

In a UI 625 shown in FIG. 19B, an image is used in which coupling positions 631 of areas 630 used as the display area image 655 are displayed. The areas 630 used as the display area image 655 refer to areas which are cut out of the display partial images 656.

The user uses the pointer 620 with respect to any one of the areas 630 to perform the drag operation or the like. As a result, a frame image 632 that indicates a frame of the area 630 is moved in accordance with the drag operation or the like. On the basis of an amount of movement of the frame image 632, the joining position between the display partial images 656 may be changed.

In addition, as the UI for the change mode of the joining position, any can be used. Further, the operation or the like for changing the joining position is not limited, and for example, an arrow key or the like of a controller may be used as appropriate to change a position for each pixel.

The server 600 that has received the change instruction determines again the joining position (Step 404), and the plurality of display partial images 656 are connected on the joining position (Step 405). Then, the display area image 655 is generated (Step 406) and is displayed by the viewer 400 (Step 407). For example, at the time when the user inputs again the change instruction of the joining position, the process from Step 401 is performed again.

As described above, in this embodiment, it is possible to correct the relative positional relationship between the two display partial images 656 while visually confirming the display area image 655. For example, in the comparative example shown in FIG. 12, one large image 950 is generated by the control PC, so it may be impossible to change the relative positional relationship of the partial image 951 later. In contrast, in this embodiment, it is possible to change the relative positional relationship thereof.

It should be noted that on the basis of the change instruction, the offset value stored in a storage unit or the like of the server 600 may be updated. That is, the change result may be stored as a new offset value. In this case, as a numerical value which indicates the reliability, a predetermined value or the like may be input which indicates that the offset value is updated on the basis of the change instruction by the user.

### Fifth Embodiment

A description will be given on an image processing system according to a fifth embodiment of the present disclosure.

In the image processing system according to this embodiment, it is possible to perform a zoom-in and zoom-out operation with respect to the display area image displayed by the viewer.

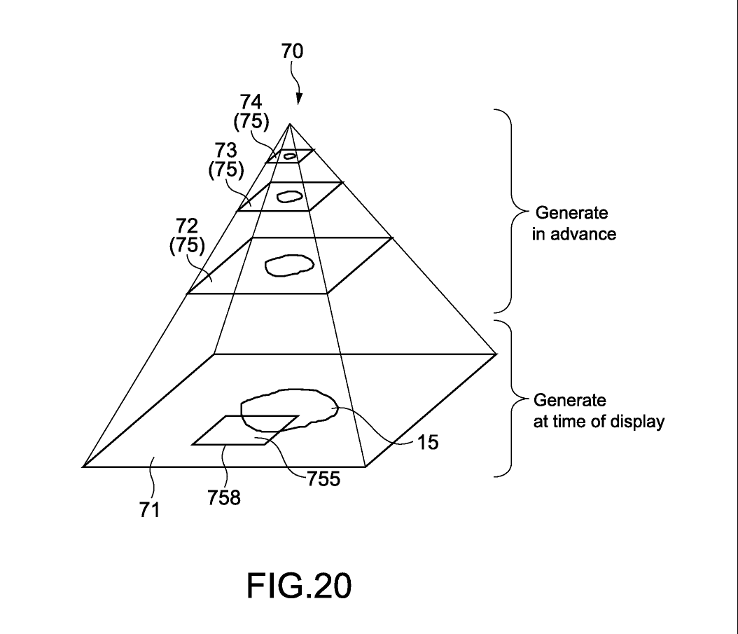

FIG. 20 is a schematic diagram for explaining a display principle of the display area image according to this embodiment. An image pyramid structure 70 shown in FIG. 20 is an image group generated with a plurality of different resolutions with respect to the same image obtained from the same subject 15 with a digital microscope.

On a lowermost portion of the image pyramid structure 70, an image 71 having the largest resolution (large size) is disposed. On an uppermost portion thereof, an image 74 having the smallest resolution (small size) is disposed. In the case where the user inputs the zoom-in and zoom-out operation, the plurality of images 71 to 74 are used as appropriate.

That is, an image corresponding to a magnification input by the user is selected from the images 71 to 74, and a display area image 755 corresponding to a position of a display area 758 in the image is generated. As a result, the zoom-in and zoom-out operation is achieved at high speed.

It should be noted that in this embodiment, the images 72 to 74 are generated in advance as an entire image 75 of the subject 15. On the other hand, the image 71 having the largest resolution is not generated as the entire image. This point will be described hereinafter.

In the image processing system according to this embodiment, in the same way as the above embodiments, the plurality of partial images are taken by the digital microscope. The plurality of partial images are output to the control PC, and the control PC calculates the offset value between the partial images and the reliability thereof.

Further, the control PC sequentially connects the plurality of partial images to each other to generate a scaled-up image of the subject 15. The scaled-up image is compressed by a known compression technique or the like, and thus the entire images 75 (72 to 74) having lower resolutions shown in FIG. 20 are generated. It should be noted that the number of entire images 75 having the low resolutions and the respective resolutions are not limited.

From the control PC to the server, the plurality of partial images, the offset values, and the information relating to the reliabilities are transmitted. Further, the entire images 75 having the lower resolutions are transmitted.

In the case where the server generates the display area image 755 at the highest magnification, the technique described in the above embodiments is used as appropriate. That is, in accordance with the position of the display area 758, the display partial images are determined from the plurality of partial images. Then, on the basis of the offset value and the reliability stored, the display partial images are connected to each other as appropriate. As a result, the display area image 755 with high accuracy is generated.

In the case where the server generates the display area image at a low magnification, the display area image 755 is generated as appropriate from the entire image 75 having the low resolution corresponding to the magnification. In the case where the display area image 755 is displayed at the low magnification, a possibility of an occurrence of the displacement problem is slim. Therefore, even if the entire image 75 having the low resolution is generated in advance, and the display area image 755 is generated from the entire image 75, a possibility of an occurrence of a problem is thought to be slim.

As described above, when the display area image 755 with a high magnification is displayed, at the time of the display, the display area image 755 is generated. For the display area image 755 with a low magnification, the entire image 75 generated in advance is used as appropriate. As a result, the zoom-in and zoom-out operation is achieved at high speed.

As described above, the technique according to the above embodiments is capable of being used in the field of medicine, pathology, or the like. In addition to the field of medicine or the like, the technique is applicable to other fields. For example, the technique described above may be used when various materials or the like are observed with the use of the digital microscope.

### Modified Example

The present disclosure is not limited to the above embodiments and variously modified.

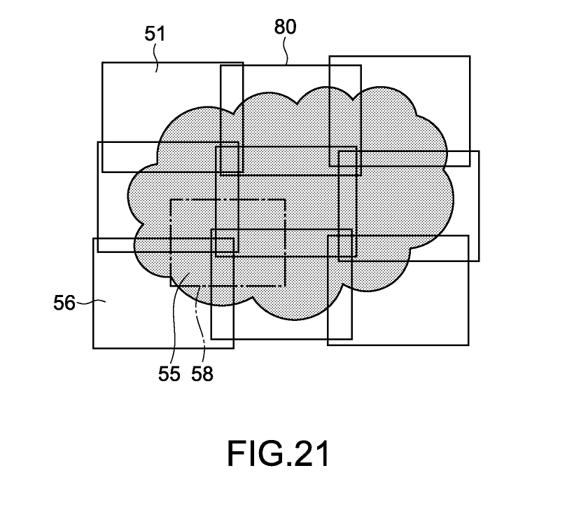

FIG. 21 is a schematic diagram for explaining a modified example of a determination process of the display area and the display partial image.

In the determination process described above, the display area 58 and the display partial image 56 are determined on the basis of the reference image 57 shown in FIG. 10. The reference image 57 is an image where the connection areas 54 are overlapped without taking the offset value into consideration.

As shown in FIG. 21, however, the display area 58 and the display partial image 56 may be determined on the basis of an image 80 where the plurality of partial images 51 are overlapped on the basis of offset values.

Further, on the basis of an image obtained by synthesizing the plurality of partial images 51 on the basis of the offset values, the determination process may be performed. Even if the displacement between the partial images 51 is accumulated in the synthesis image, a problem does not occur particularly in the determination process of the display area 58 and the display partial image 56. Therefore, the synthesis image obtained by synthesizing the plurality of partial images 51 by the stitching process may be used. In addition, as the determination method of the display area 58 and the display partial image 56, any algorism may be used.

In the above description, the reliability of the offset value is calculated by the control PC, and on the basis of the reliability, the server connects the display partial images. However, the display partial images may be connected without obtaining the reliability and using the reliability. In this case, the order of connection or the like of the plurality of display partial images may be subjected to a default setting.

In the image pyramid structure 70 described in the fifth embodiment, the plurality of partial images may be stored for each resolution without generating the entire image 75 with any resolution. The partial image having the low resolution only has to be generated by compressing the taken partial image having the high resolution. In the case where the display area image 755 having the low resolution is displayed, the display partial images corresponding to the display area 758 are determined as appropriate, and those images are connected as appropriate.

In the above description, the digital microscope 100, the control PC 200, the server 300, and the viewer 400 are used as devices separated from each other. However, the server 300 may double as the viewer. In this case, the display unit 306 shown in FIG. 3 only has to cause the display area image to be displayed, for example. That is, from the control PC to the viewer, the plurality of partial images, the offset values, and the reliability information are transmitted, and the processes according to the embodiment may be performed in the viewer.

Alternatively, the control PC 200 may perform the processes according to the embodiment. That is, by the information processing apparatus according to this embodiment, the plurality of partial images may be obtained, and the offset values and the reliability information may be calculated. Further, an object obtained by integrally configuring the digital microscope 100, the control PC 200, and the server 300 may be used as the information processing apparatus according to this embodiment.

In addition to the image of the subject obtained by the digital microscope, the present disclosure is applicable to another kind of digital image taken by a digital camera or the like.

A mode in which the above embodiments and the modified example are combined as appropriate may be adopted as an embodiment according to the present disclosure.

It should be noted that the present disclosure can take the following configurations.

(1) An information processing apparatus, including:

a storage unit configured to store a plurality of partial images obtained by taking images with respect to a subject so that a plurality of image taking areas are overlapped with each other and relative positional displacement information of two adjacent partial images out of the plurality of partial images, the positional displacement information being calculated for each of the two adjacent partial images;

a determination unit configured to determine at least one display partial image for generating a display area image from the plurality of partial images stored, the display area image being an image of an area displayed as an image of the subject; and

a generation unit configured to connect, when the determination unit determines a plurality of display partial images, the plurality of display partial images to each other on the basis of the positional displacement information stored, to generate the display area image.

(2) The information processing apparatus according to Item (1), in which

when the determination unit determines one display partial image, the generation unit generates the display area image on the basis of the one display partial image.

(3) The information processing apparatus according to Item (1) or (2), in which

when a determination result by the determination unit is changed, the generation unit uses a connection result of the plurality of display partial images before the change, to connect the plurality of display partial images after the change to each other.

(4) The information processing apparatus according to any one of Items (1) to (3), in which

the storage unit stores a reliability of the positional displacement information, and

the generation unit connects the plurality of display partial images to each other on the basis of the reliability.

(5) The information processing apparatus according to Item (4), in which

when the reliability of the positional displacement information of two adjacent display partial images is smaller than a predetermined value, the generation unit uses the positional displacement information between the two display partial images and the partial image which is not determined as the display partial image and is adjacent to the two display partial images, to connect the two display partial images to each other.

(6) The information processing apparatus according to any one of Items (1) to (5), in which

the generation unit uses the positional displacement information between the display partial image and the partial image which is not determined as the display partial image, to generate the display area image.

(7) The information processing apparatus according to any one of Items (1) to (6), further including

an instruction input unit configured to receive an instruction to change a relative position of two adjacent display partial images in the display area image generated by connecting the plurality of display partial images to each other, in which

the generation unit connects the plurality of display partial images to each other on the basis of the change instruction received.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An information processing apparatus, comprising:
a storage unit configured to store a plurality of partial images obtained by taking images with respect to a subject so that a plurality of image taking areas are overlapped with each other and relative positional displacement information of two adjacent partial images out of the plurality of partial images, the positional displacement information being calculated for each of the two adjacent partial images;
a determination unit configured to determine at least one display partial image for generating a display area image from the plurality of partial images stored, the display area image being an image of an area displayed as an image of the subject; and
a generation unit configured to connect, when the determination unit determines a plurality of display partial images, the plurality of display partial images to each other on the basis of the positional displacement information stored, to generate the display area image.

2. The information processing apparatus according to claim 1, wherein
when the determination unit determines one display partial image, the generation unit generates the display area image on the basis of the one display partial image.

3. The information processing apparatus according to claim 1, wherein
when a determination result by the determination unit is changed, the generation unit uses a connection result of the plurality of display partial images before the change, to connect the plurality of display partial images after the change to each other.

4. The information processing apparatus according to claim 1, wherein
the storage unit stores a reliability of the positional displacement information, and
the generation unit connects the plurality of display partial images to each other on the basis of the reliability.

5. The information processing apparatus according to claim 4, wherein
when the reliability of the positional displacement information of two adjacent display partial images is smaller than a predetermined value, the generation unit uses the positional displacement information between the two display partial images and the partial image which is not determined as the display partial image and is adjacent to the two display partial images, to connect the two display partial images to each other.

6. The information processing apparatus according to claim 1, wherein
the generation unit uses the positional displacement information between the display partial image and the partial image which is not determined as the display partial image, to generate the display area image.

7. The information processing apparatus according to claim 1, further comprising
an instruction input unit configured to receive an instruction to change a relative position of two adjacent display partial images in the display area image generated by connecting the plurality of display partial images to each other, wherein
the generation unit connects the plurality of display partial images to each other on the basis of the change instruction received.

8. An information processing method, comprising:
storing a plurality of partial images obtained by taking images with respect to a subject so that a plurality of image taking areas are overlapped with each other and relative positional displacement information of two adjacent partial images out of the plurality of partial images, the positional displacement information being calculated for each of the two adjacent partial images;
determining at least one display partial image for generating a display area image from the plurality of partial images stored, the display area image being an image of an area displayed as an image of the subject; and
connecting, when the determination unit determines a plurality of display partial images, the plurality of display partial images to each other on the basis of the positional displacement information stored, to generate the display area image.

9. A program causing a computer to execute
storing a plurality of partial images obtained by taking images with respect to a subject so that a plurality of image taking areas are overlapped with each other and relative positional displacement information of two adjacent partial images out of the plurality of partial images, the positional displacement information being calculated for each of two adjacent partial images,
determining at least one display partial image for generating a display area image from the plurality of partial images stored, the display area image being an image of an area displayed as an image of the subject, and
connecting, when the determination unit determines a plurality of display partial images, the plurality of display partial images to each other on the basis of the positional displacement information stored, to generate the display area image.
